(19) United States
(12) Patent Application Publication
(10) Pub. No.: US 2015/0197987 A1
(43) Pub. Date: Jul. 16, 2015

(54) LADDER LEVELING APPARATUS

(71) Applicant: W. Taylor Enterprises, Inc., Windsor Locks, CT (US)

(72) Inventor: William Moselsky, Windsor Locks, CT (US)

(21) Appl. No.: 14/151,911

(22) Filed: Jan. 10, 2014

(51) Int. Cl. E06C 7/44; E06C 7/42

(52) U.S. Cl. CPC E06C 7/44; E06C 7/423

(57) ABSTRACT

A leveling apparatus for a ladder includes a boot that has opposed pairs of long and short walls surrounding a rectilinear volume that is open at upper and lower ends of the boot; a sleeve formed integrally at one of the longer walls of the boot and extending generally parallel to the walls of the boot; a clamping fastener threadedly mounted in another wall of the boot; a shank slidingly housed in the sleeve; and a connector engaging the shank and the sleeve to hold the shank in a position selected from a plurality of pre-determined positions along the sleeve.

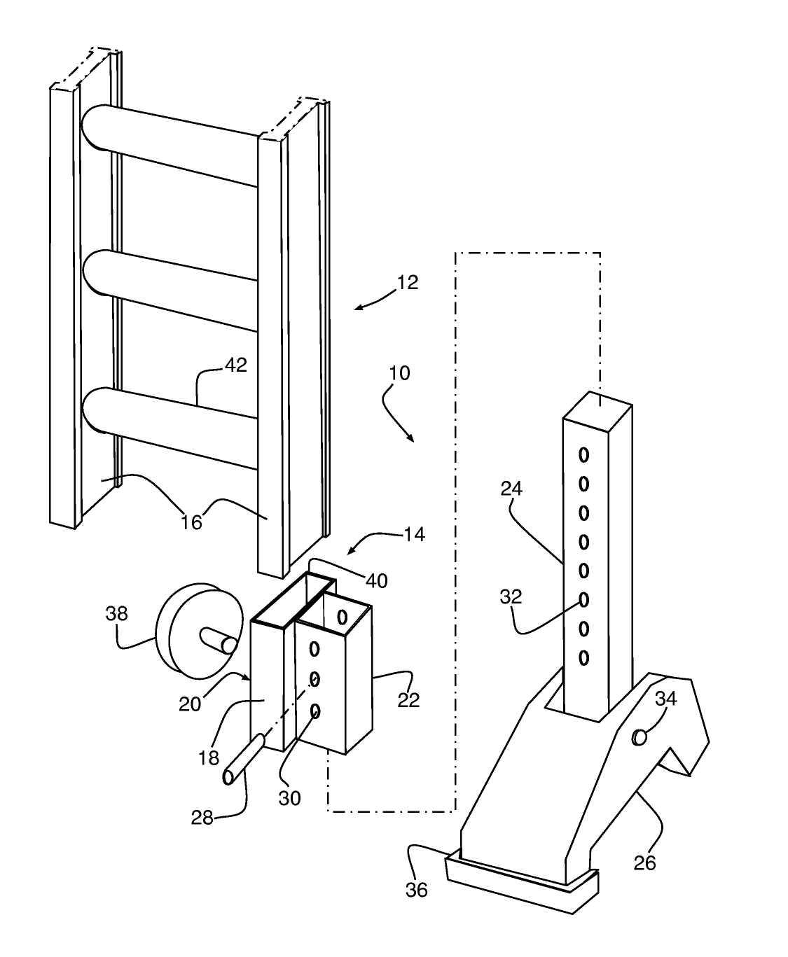

### BACKGROUND

1. Technical Field

This invention relates in general to ladder safety devices and deals more particularly with an improved stabilizing or leg leveling apparatus for a ground-supported straight ladder.

2. Discussion of Related Art

A ground supported ladder of the type with which the present invention is concerned is used in an inclined position with its upper end portion resting on or against a suitable support. When a downwardly directed force is applied to the ladder by someone standing on it, there is a natural tendency for the base of the ladder to move in a horizontal direction away from the supporting surface. Most serious accidents involving ladders of this type can be attributed to failure to provide a sound ladder footing. Long straight ladders and particularly extension ladders are inherently unstable when supported on uneven ground. When such a ladder is used on irregular or sloping surfaces it is common practice to block or shim the ladder to compensate for the irregularity of the supporting surface. This is an extremely dangerous practice, as weight on the ladder tends to force the shims out from under the legs, but in many instances the practice cannot be avoided. This is particularly true where there is no provision for adjusting the effective length of the ladder side rails.

In U.S. Pat. No. 5,522,473, I taught a ladder stabilizing device that can be attached to the lower end of a ladder side rail by way of a clip that attaches onto a flange of the ladder side rail. In order to place the clip onto the ladder side rail, it typically is necessary to first remove the original foot provided on the side rail. The clip then is clamped onto the flange of the ladder side rail by way of a threaded clamping fastener. The clip is attached along one corner to a sleeve that holds a shank generally parallel to the ladder side rail. The shank carries a support base, and is incrementally adjustable through the sleeve with respect to the clip, so that the support base can be adjusted with reference to the ladder side rail. However, the corner juncture of the sleeve and the clip is prone to flexure. Additionally, attachment of the clip to only one flange of the ladder side rail introduces heightened stress at that side rail. Further, aside from the clamping fastener, nothing prevents the clip sliding up the side rail while the ladder is loaded.

### SUMMARY OF THE INVENTION

The improvement of my present invention provides a ladder stabilizing device that can be attached to the lower end of a ladder side rail by way of a cup that fits over the entirety of the ladder side rail and engages its top edge against a rung of the ladder.

An exemplary embodiment comprises a boot that has opposed pairs of long and short walls surrounding a rectilinear volume that is open at upper and lower ends of the boot, a sleeve formed integrally at one of the longer walls of the boot and extending generally parallel to the walls of the boot, a clamping fastener threadedly mounted in another wall of the boot, a shank slidingly housed in the sleeve, and a connector engaging the shank and the sleeve to hold the shank in a position selected from a plurality of pre-determined positions along the sleeve.

These and other objects, features and advantages of the present invention will become apparent in light of the detailed description thereof, as illustrated in the accompanying drawings.

### BRIEF DESCRIPTION OF DRAWINGS

THE DRAWING shows in perspective view a ladder, and attached to the ladder, a leveling apparatus according to a first embodiment of the present invention.

### DETAILED DESCRIPTION OF DRAWINGS

Referring to THE DRAWING, a leveling apparatus 10, according to an embodiment of the invention, is attachable to a ladder 12 by way of a boot 14, which can be slid onto a lower end of a side rail 16 of the ladder 12. As shown, the boot 14 includes opposed pairs of long walls 18 and short walls 20 that surround openings at an upper edge and at a lower edge of the walls. In addition to the boot 14, the leveling apparatus 10 includes a sleeve 22, which is integrally formed at one of the long walls 18. The sleeve 22 also has openings at upper and lower ends, and slidingly houses a shank or shank 24. The shank 24 at its lower end carries a foot 26.

The leveling apparatus 10 is configured so that the foot 26 can be vertically adjustable in order to accommodate uneven ground beneath the ladder 12. For example, a connector 28 is provided to engage with the shank 24 and the sleeve 22 so that the shank is releasably positionable within the sleeve among a plurality of pre-determined positions such as connector holes 30, 32.

Thus, in case the ground is lower under a given leg of the ladder 12 than under the other leg, then the connector 28 can be disengaged for lowering the shank 24 in its sleeve 22 to engage the foot 26 against the ground with the ladder in an upright position. The connector 28 then can be re-engaged to secure the shank 24 in its proper ladder-leveling position. For example, the shank 24 may be secured by a connector 28, which is inserted through one of a plurality of holes 30 that are formed in the sleeve 22. The connector 28 then engages into one of a plurality of holes or dents 32 that are indented through or into the shank 24 at intervals along its length. As shown, the holes 32 and the connector 28 extend through the shank 24, however, this is not essential to the operation of the invention. For example, although a ball connector 28 is shown, a sufficiently sturdy threaded clamping fastener, or a pawl arranged to engage with notches of the shank 24 to resist upward motion of the shank 24 within the sleeve 22, could work as well for securely positioning the post. Other connectors for positioning the shank 24 will be apparent to those of skill.

The exemplary foot 26 has a bowed or generally C-shaped profile, and is attached to the lower end of the shank 24 by way of a pivot 34, which provides for a rocking motion of the foot in a plane generally parallel to the long wall 18 of the boot 14, in order to accommodate slant away from a wall of the ground supporting the ladder 12 against the wall. For additional stability, molded rubber shoes 36 may be attached over ends of the foot 26.

In the exemplary embodiment of THE DRAWING, the shank 24 and the sleeve 22 are square or oblong in cross section. It is believed that other shapes would work as well. Sections including a straight line segment make it easier to align the connector 28 with the holes, dents, or notches 30, 32.

In the exemplary embodiment of THE DRAWING, the boot 14 is clamped onto the side rail 16 by a clamping fastener 38. Preferably, the clamping fastener 38 is disposed at an inward or rear wall of the boot 14, so as to avoid snagging a ladder user's leg. The boot 14 is installed onto the side rail 16 in place of the foot ordinarily provided. The boot 14 is open-ended to slide up the side rail 16 until an upper edge 40 of the boot rests against an under surface of a first ladder rung 42. The clamping fastener 38 then prevents the boot 14 slipping off the side rail 16, while the ladder rung 42 prevents the ladder slipping down within the boot 14. As the vast majority of ladders have side rails of a common size, a few variations of the boot 14 section can encompass the entirety of the market for adjustable ladder legs.

Thus, according to certain embodiments of the invention, a leveling apparatus for a ladder comprises a boot that has opposed pairs of long and short walls surrounding a rectilinear volume that is open at upper and lower ends of the boot, a sleeve formed integrally at one of the longer walls of the boot and extending generally parallel to the walls of the boot, a clamping fastener threadedly mounted in another wall of the boot, a shank slidingly housed in the sleeve, and a connector engaging the shank and the sleeve to hold the shank in a position selected from a plurality of pre-determined positions along the sleeve.

Although exemplary embodiments of the invention have been described with reference to attached drawings, those skilled in the art will apprehend various changes in form and detail consistent with the scope of the invention as defined by the appended claims.

What is claimed is:

1. A leveling apparatus for a ladder, said apparatus comprising:
a boot that has opposed pairs of long and short walls surrounding a rectilinear volume that is open at upper and lower ends of the boot;
a sleeve formed integrally at one of the longer walls of the boot and extending generally parallel to the walls of the boot;
a clamping fastener threadedly mounted in another wall of the boot;
a shank slidingly housed in the sleeve; and
a connector engaging the shank and the sleeve to hold the shank in a position selected from a plurality of pre-determined positions along the sleeve.

2. The leveling apparatus as claimed in claim 1, wherein the clamping fastener is mounted in the other long wall of the boot.

3. The leveling apparatus as claimed in claim 1, wherein the connector is a pin insertable into any of first and second pluralities of connector holes respectively formed in the sleeve and in the shank.

4. The leveling apparatus as claimed in claim 1, further comprising a foot attached at a lower end of the shank.

5. The leveling apparatus as claimed in claim 4, wherein the foot is attached by a pivot at the lower end of the shank.

6. A ladder comprising:
a first side rail;
a second side rail;
rungs joining the side rails, the rungs including a lowest rung; and
a leveling apparatus as claimed in claim 1,
wherein the boot of said leveling apparatus is slidingly attached over a lower end of one of said side rails with an upper edge of said boot contacting said lowest rung of said ladder, and with the clamping fastener of said leveling apparatus threadedly clamped against said one of said side rails.

7. The ladder as claimed in claim 6, further comprising a second leveling apparatus as claimed in claim 1,
wherein the boot of said second leveling apparatus is slidingly attached over a lower end of the other of the side rails with an upper edge of said boot contacting the lowest rung of said ladder, and with the clamping fastener of said leveling apparatus threadedly clamped against said other of said side rails.

8. The ladder as claimed in claim 7, wherein the shank of said leveling apparatus is secured in a first position to extend to a first length beyond a lower end of its sleeve, and the shank of said second leveling apparatus is secured in a second position to extend to a second length beyond a lower end of its sleeve, said first and second lengths being different, thereby providing said ladder with legs of different lengths.
